(19) United States
(12) Patent Application Publication
(10) Pub. No.: US 2009/0029818 A1
(43) Pub. Date: Jan. 29, 2009

(54) Flat transmission belt

(75) Inventor: Osamu Takahashi, Hyogo (JP)

Correspondence Address: THE WEBB LAW FIRM, P.C., 700 KOPPERS BUILDING, 436 SEVENTH AVENUE, PITTSBURGH, PA, 15219, US

(73) Assignee: Bando Chemical Industries LTD, Hyogo (JP)

(21) Appl. No.: 11/920,479

(22) PCT Filed: May 15, 2006
(86) PCT No.: PCT/JP2006/309654

§ 371 Date: Nov. 15, 2007

(30) Foreign Application Priority Data
May 16, 2005 (JP) 2005-143023

(51) Int. Cl. F16G 1/08

(52) U.S. Cl. 474/263

(57) ABSTRACT

There is provided a flat transmission belt that suppresses occurrence of cracks in the belt surfaces to extend the life of cover rubber layers and hence the life of the belt as a whole. A flat transmission belt of the present invention has a first cover rubber layer and a second cover rubber layer formed on a side of the belt opposite to the side on which the first cover rubber layer is formed, and is wound between driving and driven pulleys when in use. The first cover rubber layer and the second cover rubber layer are respectively formed of rubber materials that are of the same kind but differ in mixing ratio of the components thereof, and the first cover rubber layer, which contacts a smaller number of the driving and driven pulleys, has an extension ratio higher than the extension ratio of the second cover rubber layer, which contacts a larger number of the driving and driven pulleys.

### FIELD OF THE INVENTION

The present invention relates to a flat transmission belt and more relates to a flat transmission belt that is wound around plural shafts as being bent, and is capable of being used for double-sided power transmission.

### BACKGROUND OF THE INVENTION

V-ribbed belts, flat belts and the like are used as transmission belts and these are used in various fields, such as automobiles, general industry machineries, electric equipments and office automation equipments.

A V-ribbed belt has plural rib grooves on its inner side in a direction orthogonal to the longitudinal direction of the belt, and is wound around shafts (pulleys), each having a ribbed portion provided to be respectively engaged with the rib grooves, thereby transmitting high power to the pulleys.

On the contrary, a flat belt has an inner side and an outer side, to which rubber formed of the same material is bonded, so that all the sides of the flat belt are formed into flat. Accordingly, the flat belt can be wound around plural pulleys to have the inner side and the outer side of the belt being held in contact with the plural pulleys, and therefore it is easy to be used in a complicated arrangement where a large number of pulleys are disposed. Since a flat belt forms no rib grooves unlike a V-ribbed belt, pulleys on which the belt is to be wound are not required to have ribbed portions, which contributes to low cost.

FIG. 2 is a schematic entire view of an example of a conventional arrangement, in which a flat transmission belt of the above type is used for a car-mounted engine. As illustrated in FIG. 2, a flat transmission belt 10 is, in the clockwise order starting from a crank pulley 21, wound around a tension pulley 31, alternator pulleys 22, 23, an oil-pump pulley 24, an idler pulley 32, a power-steering pulley 25, an idler pulley 33, an air-conditioner pulley 26 and a water-pump pulley 34.

The crank pulley 21 is mounted on a crank shaft as an output shaft of the car-mounted engine, and is rotated in a clockwise direction with a predetermined torque. The tension pulley 31 is provided to an auto-tensioner for adjusting the tension of the flat transmission belt 10. The alternator pulleys 22, 23 are mounted on input shafts of an alternator. The oil-pump pulley 24 is mounted on an input shaft of an oil pump. The power-steering pulley 25 is mounted on an input shaft of a power steering device of an automobile. The air-conditioner pulley 26 is mounted on an input shaft of an air compressor of the automobile. The water-pump pulley 34 is mounted on an input shaft of a water pump.

Of those pulleys, the crank pulley 21 is a driving pulley for drivingly rotating the flat transmission belt 10. The alternator pulleys 22, 23, the oil-pump pulley 24, the power-steering pulley 25, the air-conditioner pulley 26 and the water-pump pulley 34 are driven pulleys that transmit power to the respective input shafts upon receiving the torque of the flat transmission belt 10 that is being drivingly rotated by the crank pulley 21.

The flat transmission belt 10, which is thus wound therearound with tension by the tension pulley 31, is entirely subjected to tensile stress. Since the flat transmission belt 10 is bent inwards or outwards by the respective pulleys, the inner and outer sides of the belt are repeatedly compressed and elongated when the belt is moved via the pulleys and power is transmitted through the belt. Thus, a conventional belt is designed to have the same characteristics for both the front and back sides to be tolerable against tensile stress, and elongation and contraction.

### SUMMARY OF THE INVENTION

### Problems to be Solved by the Invention

However, the flat belt, which is used in a layout of the plural shafts, as illustrated in FIG. 2, is likely to cause crack in one of the belt surfaces, and thus poses a problem that it cannot be used as a whole, although the opposite belt surface has a strength enough to be tolerable against the use.

In consideration of the above problem, it is an object of the present invention to provide a flat transmission belt that suppresses the possibility to cause cracks in the belt surfaces to extend the life of cover rubber layers and hence the life of the belt as a whole.

### Means of Solving the Problems

In order to solve the above problem, the present inventor earnestly studied and found that even for the layout of plural shafts, for which the same characteristics are seemed to be required for both the front and back sides of the belt, different characteristics are actually required depending on the arrangement of the pulleys.

Specifically, a flat transmission belt of the present invention has a first cover rubber layer and a second cover rubber layer formed on a side of the belt opposite to the side on which the first cover rubber layer is formed, and is wound between driving and driven pulleys when in use. The flat transmission belt is characterized in that the first cover rubber layer and the second cover rubber layer are respectively formed of rubber materials that are of the same kind but differ in mixing ratio of the components thereof, and the first cover rubber layer, which contacts a smaller number of the driving and driven pulleys, has an extension ratio higher than the extension ratio of the second cover rubber layer, which contacts a larger number of the driving and driven pulleys.

According to the above flat transmission belt, the rubber materials, which are respectively mixed into the cover rubber layers on the front and back sides of the belt to enable the first cover rubber layer to have a high extension ratio, are of the same kind but differ in mixing ratio of the components thereof. With this arrangement, stress applied on the belt surfaces can be reduced, thereby suppressing the occurrence of cracks in the belt surfaces and hence enabling extension of the life of the cover rubber layers. Thus, the belt as a whole can be used for a prolonged time.

The rubber materials preferably contain short fibers, in which the short fibers contained in the rubber material of the first cover rubber layer is smaller in amount than the short fibers contained in the rubber material of the second cover rubber layer. With this, it is possible to enable the first cover rubber layer to have a extension ratio higher than that of the second cover rubber layer and suppress the occurrence of cracks. Thus, the belt as a whole can be used for a prolonged time.

The rubber hardness of the first cover rubber layer is preferably smaller than that of the second cover rubber layer. Or, the rubber elastic modulus of the first cover rubber layer is smaller than that of the second cover rubber layer. The mechanical properties of the rubbers are thus differentiated between the front side and the rear side so as to enable the first cover rubber layer to have a highly stretchable rubber composition, so that it is possible to suppress the occurrence of cracks. Thus, the belt as a whole can be used for a prolonged time.

It is preferable that the rubber hardness of the second cover rubber layer is 70-98 and the rubber hardness of the first cover rubber layer is 3-10 smaller than the rubber hardness of the second cover rubber layer in the rubber hardness test according to JIS K6253. When the difference in rubber hardness between the inner cover rubber layer and the outer cover rubber layer exceeds 10, abnormal noises may be generated at the surface of the outer cover rubber layer, and when the outer cover rubber layer contacts the pulleys, the contact resistance becomes increased and hence a stress-strain is caused, which may cause delamination of the outer cover rubber layer. On the other hand, when the difference in rubber hardness between the inner cover rubber layer and the outer cover rubber layer is less than 3, the extension ratio is lowered and hence cracks are easy to occur.

### ADVANTAGE OF THE INVENTION

According to the flat transmission belt of the present invention, the first cover rubber layer and the second cover rubber layer are formed of resin materials that are of the same kind but differ in mixing ratio of the components thereof to enable the first cover rubber layer to have a higher extension ratio, and therefore it is possible to suppress occurrence of cracks in the outer surfaces of the belt, and extend the life of the first cover rubber layer and hence the life of the belt as a whole.

### BRIEF DESCRIPTION OF THE DRAWINGS

FIG. 1 is a cross sectional view of a portion of a flat transmission belt according to an embodiment of the present invention.

FIG. 2 is a schematic entire view of a conventional arrangement, in which the flat transmission belt is used for a car-mounted engine.

### DESCRIPTION OF THE REFERENCE CODES

10: flat transmission belt
11: core codes
12: adhesive rubber layer
13: inner cover rubber layer
14: outer cover rubber layer

### BEST MODE FOR CARRYING OUT THE INVENTION

Now, the description will be made for an embodiment of the present invention with reference to the attached drawings.

### EMBODIMENT

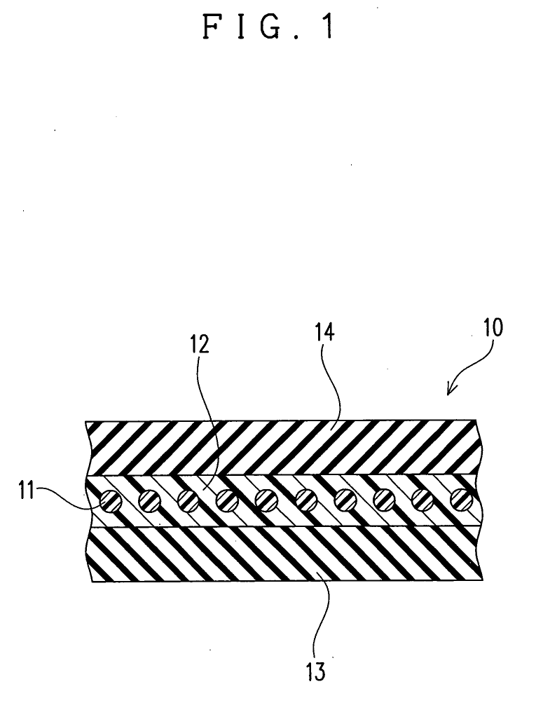

FIG. 1 is a cross sectional view of a portion of a flat transmission belt according to an embodiment of the present invention.

As illustrated in FIG. 1, a flat transmission belt 10 is made up of a laminate of an adhesive rubber layer 12 with plural core codes 11 embedded therein in the longitudinal direction of the belt, an outer cover rubber layer 14 (first cover rubber layer) adhered to the outer side of the adhesive rubber layer 12 and an inner cover rubber layer 13 (second cover rubber layer) adhered to the inner side of the adhesive rubber layer 12.

The description will be made for a method of manufacturing the thus structured flat transmission belt 10. First, the outer cover rubber layer 14, the inner cover rubber layer 13 and the adhesive rubber layer 12 made up of a pair of layer members are each formed into a strip. Then, a first layer member of the adhesive rubber layer 12 is laid on an upper side of the inner cover rubber layer 13, then the plural core codes 11 are laid thereon in the longitudinal direction of the belt at an equal interval, and then a second layer member of the adhesive rubber layer 12 is laid thereon. Then, the outer cover rubber layer 14 is laid on an upper side of the second layer member of the adhesive rubber layer 12. Then, they are pressed and heated by a press so that the adhesive rubber layer 12 with the core codes 11 embedded therein, the outer cover rubber layer 14 and the inner cover rubber layer 13 are bonded into an integral body. Thus, the flat transmission belt 10 of the present invention can be manufactured.

As a material of the core codes 11, it can be cited without limitation polyester fibers, aramid fibers, polyamide fibers, polyethylene naphthalate, high-strength polyvinyl alcohol and the like.

As a rubber material of the adhesive rubber layer 12, it can be cited without limitation chloroprene rubber (CR), ethylene propylene diene monomer rubber (EPDM), hydrogenated nitrile rubber (H-NBR), alkylated chlorosulfonated polyethylene (ACSM) and the like. They may be used alone or in mixture of two or more kinds.

As rubber materials of the outer cover rubber layer 14 and the inner cover rubber layer 13, it can be cited without limitation chloroprene rubber (CR), ethylene propylene diene monomer rubber (EPDM), hydrogenated nitrile rubber (H-NBR), alkylated chlorosulfonated polyethylene (ACSM) and the like. They may be used alone or in mixture of two or more kinds.

In addition to the above rubber materials, additive, such as short fibers or filler may be appropriately added to the outer cover rubber layer 14 and the inner cover rubber layer 13.

As examples of the short fibers, it can be cited organic polymer fibers, such as polyester short fibers, polyamide short fibers, aramid short fibers and cellulose short fibers, and inorganic fibers of silicon carbide or potassium titanate. They may be used alone or in mixture of two or more kinds.

The short fibers contained in the flat transmission belt of the present invention has a fiber diameter of 5-40 μm and a fiber length of 0.1-10 mm.

As the filler, it can be cited carbon black, silica, calcium carbonate or the like. They may be used alone or in combination of two or more kinds.

In the flat transmission belt of the present invention, the amounts of the rubber materials are differentiated between the outer cover rubber layer 14 and the inner cover rubber layer 13 to enable the outer cover rubber layer 14 to have a higher extension ratio when the surfaces of the outer cover rubber layer 14 and the inner cover rubber layer 13 are both wound on plural pulleys.

For example, it is possible to adjust the amount of short fibers added to each of the outer cover rubber layer 14 and the inner cover rubber layer 13. Specifically, the short fibers contained in the outer cover rubber layer 14 is preferably smaller in amount than the short fibers contained in the inner cover rubber layer 13. When the amount of the contained short fibers is small, the extension ratio of the belt is increased but abnormal noises may be generated at the surface of the outer cover rubber layer 14. On the other hand, when the amount of the contained short fibers is large, the extension ratio of the belt is decreased and hence cracks are easy to occur.

In addition to the aforesaid adjustment of the amount of the short fibers, it is possible to adjust the amount of filler to be added to each of the outer cover rubber layer 14 and the inner cover rubber layer 13. Specifically, the filler contained in the outer cover rubber layer 14 is preferably smaller in amount than the filler contained in the inner cover rubber layer 13. When the amount of the contained filler is small, the extension ratio of the belt is increased but the problem is caused that the reinforcing property is reduced. On the other hand, when the amount of the contained filler is large, the extension ratio is decreased and hence cracks are easy to occur.

In addition to the aforesaid adjustment of the amount of the short fibers, the filler or the like, it is possible to adjust the rubber hardness of each of the outer cover rubber layer 14 and the inner cover rubber layer 13. Specifically, the rubber hardness of the outer cover rubber layer 14 is preferably smaller than the rubber hardness of the inner cover rubber layer 13. With respect to the rubber hardness measured by the testing method for vulcanized rubber and thermoplastic rubber according to JIS K6253, the inner cover rubber layer 13 preferably has a rubber hardness of 70-98, and the rubber hardness of the outer cover rubber layer 14 is preferably 3-10 smaller than the rubber hardness of the inner cover rubber layer 13. When the difference in rubber hardness between the inner cover rubber layer 13 and the outer cover rubber layer 14 exceeds 10, the extension ratio of the belt is increased but abnormal noises may be generated at the surface of the outer cover rubber layer 14. When the outer cover rubber layer 14 contacts the pulleys, the contact resistance becomes increased and hence a stress-strain is caused, which may cause delamination of the outer cover rubber layer 14. On the other hand, when the difference in rubber hardness between the inner cover rubber layer 13 and the outer cover rubber layer 14 is less than 3, the extension ratio is lowered and hence cracks are easy to occur. The rubber hardness can be adjusted by, for example, changing the mixing ratio of additive, such as short fibers and filler.

When the outer cover rubber layer 14 and the inner cover rubber layer 13 each have the aforesaid corresponding rubber hardness, the rubber elastic modulus measured by the method of determining vulcanized rubber and thermoplastic rubber-tensile property defined in JIS K6251 is 0.5-2.5 MPa in the outer cover rubber layer 14 and 0.55-7 MPa in the inner cover rubber layer 13.

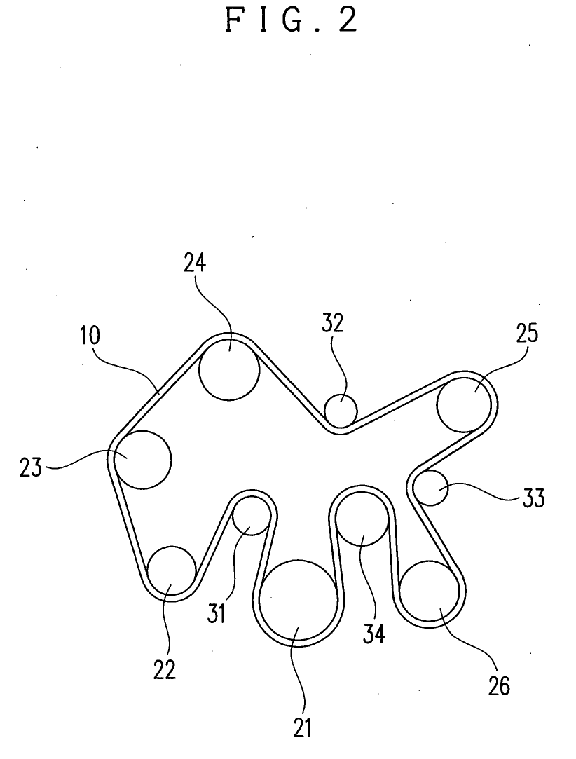

Thus, the flat transmission belt of this embodiment has the inner cover rubber layer 13 and the outer cover rubber layer 14 that are formed of the rubber materials that are of the same kind but differ in mixing ratio of the components thereof. When this flat transmission belt is used in a conventional transmission device having plural shafts, as illustrated in FIG. 2, tensile stress applied to the outer cover rubber layer 14 can be reduced and therefore it is possible to prevent occurrence of cracks caused in the belt surfaces. Thus, the belt as a whole can be used for a prolonged time.

According to the flat transmission belt of the present invention, the amount of contained short fibers or filler, or the value of any one of the rubber hardness and the rubber elastic modulus is changed. However, the present invention is not necessarily limited thereto, and two or more values thereof may be changed.

1: A flat transmission belt, the transmission belt having a first cover rubber layer and a second cover rubber layer on a side of the flat transmission belt opposite to the side on which the first cover rubber layer is formed, and is wound between driving and driven pulleys when in use, wherein the first cover rubber layer and the second cover rubber layer are respectively formed of rubber materials that are of the same kind but differ in mixing ratio of the components thereof; and the first cover rubber layer, which contacts a smaller number of the driving and driven pulleys, has an extension ratio higher than the extension ratio of the second cover rubber layer, which contacts a larger number of the driving and driven pulleys.

2: The flat transmission belt according to claim 1, wherein the rubber materials each contain short fibers and the short fibers contained in the rubber material of the first cover rubber layer is smaller in amount than the short fibers contained in the rubber material of the second cover rubber layer.

3: The flat transmission belt according to claim 1, wherein the rubber materials each contain filler and the filler contained in the rubber material of the first cover rubber layer is smaller in amount than the filler contained in the rubber material of the second cover rubber layer.

4: The flat transmission belt according to claim 1, wherein the rubber hardness of the first cover rubber layer is smaller than that of the second cover rubber layer.

5: The flat transmission belt according to claim 4, wherein the rubber hardness of the second cover rubber layer is 70-98 and the rubber hardness of the first cover rubber layer is 3-10 smaller than the rubber hardness of the second cover rubber layer in the rubber hardness test according to JIS K6253.

6: The flat transmission belt according to claim 1, wherein the rubber elastic modulus of the first cover rubber layer is smaller than that of the second cover rubber layer.
